(19) United States
(12) Patent Application Publication
(10) Pub. No.: US 2023/0391001 A1
(43) Pub. Date: Dec. 7, 2023

(54) CONTINUOUS AND SEMI-CONTINUOUS ADDITIVE MANUFACTURING SYSTEMS AND METHODS

(71) Applicant: VulcanForms Inc., Burlington, MA (US)

(72) Inventors: Martin C. Feldmann, Sudbury, MA (US); Raghav Aggarwal, Somerville, MA (US); Anastasios John Hart, Waban, MA (US); Brent Jerome Brunell, Clifton Park, NY (US)

(73) Assignee: VulcanForms Inc., Burlington, MA (US)

(21) Appl. No.: 18/204,051

(22) Filed: May 31, 2023

Related U.S. Application Data
(60) Provisional application No. 63/439,692, filed on Jan. 18, 2023.
(60) Provisional application No. 63/347,824, filed on Jun. 1, 2022.

(51) Int. Cl. B29C 64/182; B29C 64/245; B29C 64/379; B29C 64/268; B29C 64/209; B29C 64/364

(52) U.S. Cl. CPC B29C 64/182; B29C 64/245; B29C 64/379; B29C 64/268; B29C 64/209; B29C 64/364; B33Y 30/00

(57) ABSTRACT

Systems and methods for additive manufacturing are generally disclosed. Additive manufacturing may be performed in a continuous manner and/or semi-continuous manner by transporting one or more build plates relative to printheads that comprise a plurality of energy source arrays and/or binderjet arrays that may be selectively activated to form a desired pattern in a material layer disposed on the one or more build plates.

### CROSS-REFERENCE TO RELATED APPLICATIONS

This application claims priority under 35 U.S.C. § 119(e) to U.S. Provisional Application Ser. No. 63/439,692, filed Jan. 18, 2023 and U.S. Provisional Application Ser. No. 63/347,824, filed Jun. 1, 2022, both entitled “CONTINUOUS AND SEMI-CONTINUOUS ADDITIVE MANUFACTURING SYSTEMS”, each of which is incorporated herein by reference in its entirety for all purposes.

### FIELD

Disclosed embodiments are related to continuous and semi-continuous additive manufacturing systems and methods.

### BACKGROUND

Additive manufacturing is a useful technique for the fabrication of objects of different shapes and sizes. This technique adds material in a layer-by-layer manner to create an object. The technique may also use data from computer-aided-design (CAD) software or 3D object scanners to direct hardware to deposit the material, layer upon layer, in precise geometric shapes.

### SUMMARY

In one aspect, an additive manufacturing system is described comprising a conveyer configured to transport a plurality of build plates from a first location to a second location and a plurality of energy source arrays disposed between the first location and the second location, wherein each of the plurality of energy source arrays is configured to selectively activate and direct energy towards the plurality of build plates as each build plate is transported by the conveyer from the first location to the second location.

In another aspect, a manufacturing method is described, the method comprising transporting a build plate from a first location to a second location and selectively activating one or more of a plurality of energy source arrays disposed between the first location and the second location as the build plate is transported between the first location and the second location to melt or fuse one or more portions of a material layer on the build surface.

In another aspect, an additive manufacturing system is described, the system comprising a conveyer configured to transport a plurality of build plates from a first location to a second location; and a plurality of printheads disposed between the first location and the second location, wherein each printhead of the plurality of printheads is configured to selectively activate to selectively fuse one or more portions of a material layer disposed on the plurality of build plates as each build plate of the plurality of build plates is transported by the conveyer from the first location to the second location.

In yet another aspect, a manufacturing method is described, the method comprising transporting a build plate from a first location to a second location; and selectively activating one or more of a plurality of printheads disposed between the first location and the second location as the build plate is transported between the first location and the second location to selectively fuse one or more portions of a material layer on a build surface of the build plate.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a schematic diagram of an additive manufacturing system, according to some embodiments;

FIG. 1B is a schematic diagram of an additive manufacturing system, according to some embodiments;

FIG. 2 is a schematic diagram of an additive manufacturing system, according to some embodiments;

FIGS. 3A-3B are schematic diagrams showing the vertical movement of the build plates from one layer to the next layer, according to some embodiments;

FIGS. 4A-4B schematically illustrates the relative motion between the recoater and build plate using movement of the recoater and laser energy sources, according to some embodiments;

FIGS. 5A-5B schematically illustrate an additive manufacturing system where redundant laser energy sources may be used to increase the reliability of the overall system, according to some embodiments;

FIG. 6 is a flowchart showing a process for operating of an additive manufacturing system, according to some embodiments;

FIG. 7 is a flowchart showing a process for operating an additive manufacturing system utilizing redundant laser energy sources such that when a failure is detected in one of the active laser energy sources, the redundant laser energy sources can be controlled to mitigate the failure, according to some embodiments;

FIG. 8 is a schematic representation of an additive manufacturing system, according to some embodiments;

FIG. 9 is a schematic diagram of an additive manufacturing system, according to some embodiments; and

FIG. 10 is a flowchart showing a process for operating of an additive manufacturing system, according to some embodiments.

### DETAILED DESCRIPTION

The following disclosure describes systems and methods for continuous or semi-continuous additive manufacturing. Additive manufacturing techniques provide for the layer-by-layer formation of an object. As each layer is formed, precise details of the object are fabricated using a bottom-up approach to form details in the object, one layer at a time. These additive fabrication techniques have been adapted to industrial processes, for example, for the manufacture of components including but not limited to consumer devices such as smartphones, tablets, and computers. Because additive manufacturing techniques build an object layer by layer, multiple iterations may be implemented in order to form the full object. In some embodiments, the system comprises one or more printheads (e.g., comprising optical assemblies, laser energy sources, and/or binderjet arrays), which can be used to form layers on one or more build plates. Additionally, a system may include a printhead assembly configured to fuse a portion of a layer of material on a build surface that translates across the build surface of the system and may change direction multiple times when scanning across the build surface to form an individual layer. This results in a system comprising a printhead assembly (e.g., comprising one or more optical assemblies and/or the binderjet assemblies), or other optics assembly, undergoing multiple changes in direction during a scanning procedure of each individual build layer. Each of these changes in direction may be associated with an acceleration and deceleration of the optical assembly. Each acceleration/deceleration cycle necessarily slows down the manufacturing process, as layers cannot be formed during acceleration/deceleration and, in some cases, up to 75% of the time spent manufacturing an object using conventional additive manufacturing techniques is spent during acceleration/deceleration phases of the build process.

The Inventors have recognized and appreciated that the rate of an additive manufacturing process can be increased by performing the process in a continuous and/or semi-continuous manner. As is described in more detail further below, this may be accomplished in a variety of ways. One way is to include a conveyance system within the additive manufacturing system wherein one or more build surfaces can be moved relative to a series of printheads, which may correspond to an array of laser energy sources and/or a series of binderjet arrays to form a desired pattern on the build surface. During such a process, sequential layers of material, such as powder, may be applied to the build surface and desired portions of the sequential layers may be selectively fused by the series of printheads (e.g., laser energy source arrays and/or the binderjet arrays) to build a part on a build surface as the build surfaces are repeatedly moved through the additive manufacturing system. For example, one or more build plates with corresponding build surfaces may be moved between an input and output of an additive manufacturing system multiple times to move the one or more build plates past one or more printheads (e.g., printheads comprising laser energy source arrays and/or one or more binderjet arrays) during a manufacturing process. The printheads may be selectively activated as the build plates move past each printhead to selectively fuse a portion of the layer of material disposed on the build surfaces of the build plates as the build plates move past each printhead. Advantageously, by utilizing a continuous and/or semi-continuous additive manufacturing process, acceleration and/or deceleration of components of the system can be reduced, increasing the efficiency (e.g., reducing the time spent) in manufacturing the desired object(s) (e.g., a component of a device, an entire device) on the build surfaces of one or more corresponding build plates of the system.

Accordingly, various embodiments described by the present disclosure relate to additive manufacturing systems and related methods in which an object may be fabricated using a material (e.g., a powder, powder within a powder layer) deposited on one or more build plates. The one or more build plates can be conveyed (e.g., using a conveyer system) past one or more printheads (e.g., one or more printheads each comprising a plurality of optical and/or binderjet arrays). Each energy source of the array (e.g., laser energy array source of a plurality of laser energy array sources and/or each binderjet array of the plurality of binderjet arrays) may be selectively operated to cause powder of a powder layer disposed on a given build plate to melt (e.g., fuse, bind two or more powder particles to one another) to form a layer comprising the powder material to form the object. In some embodiments, each array (e.g., a laser energy array source of the plurality of laser energy array sources and/or each binderjet array of a plurality of binderjet arrays) may be positioned to interact with a different portion of the powder layer as the corresponding build plate is moved through the system. After passing through an array (e.g., each laser energy source and/or each binderjet array), the one or more build plates may be moved from an output to an input of the system using any appropriate build plate handling system as elaborated on below. In this manner, the build plates may be moved from the end of the printheads (e.g., the plurality of optical assemblies and/or from the end of the plurality of binderjet assemblies) back to the beginning of the printheads (e.g., plurality of optical assemblies and/or the beginning of the plurality of binderjet assemblies), so that an additional powder layer can be deposited onto the build plate for subsequent layer formation by the printheads (e.g., optical and/or binderjet arrays within the printheads).

In some embodiments, a continuous and/or semi-continuous additive manufacturing system includes a conveyer in the form of a loop configured to transport a plurality of build plates from an initial position (e.g., a first location) which may correspond to an input to the additive manufacturing system, to a final position (e.g., a second location) which may correspond to an output of the additive manufacturing system, and back to the initial position. Each build plate may comprise a substrate and/or a forming object, and, as the build plate moves from the initial position to the final position, and back to the initial position during the formation of each layer, the system may also include a plurality of printheads configured to fuse a precursor material disposed on the various build plates as the build plates are translated relative to the printheads. For example, the plurality of printheads may correspond to a plurality of optical assemblies where each optical assembly includes an array of laser energy sources, and where each array includes a plurality of laser energy sources in a desired layout. In some embodiments, the plurality of printheads may include a plurality of binderjet assemblies where each binderjet assembly includes an array of binderjets corresponding to a plurality of printheads in a desired layout. In some embodiments, the printheads include a combination of an array of laser energy sources and binderjet arrays. Regardless of the specific type of fusing method, the serially arranged printheads disposed between the first location and the second location may be used to selectively fuse, bind and/or melt powder on the build plates to form a desired pattern in each layer. In some embodiments, the system includes a plurality of optical assemblies and/or a plurality of binderjet arrays. By using a plurality of build plates that are moved relative to one or more stationary optical assemblies and/or binderjet assemblies, the inefficiencies associated with the acceleration and deceleration of the printheads (e.g., arrays of laser energy sources and/or binderjet arrays) compared to a non-continuous system may be decreased, which may increase the efficiency of the process described herein. Additional details of the systems and methods are described in more detail below.

In some embodiments, the additive manufacturing system comprises a conveyer (e.g., a conveyer system). As mentioned above, in some embodiments, the conveyer is a loop, which may return one or more build plates on the conveyer from a first position, to a second position, and, subsequently, return the one or more build plates to the first position. In some embodiments, the conveyer is configured to recirculate the build plates from the second location to the first location. Of course, it should be understood that the conveyer may move the build plate to additional positions (e.g., a third position, a fourth position, a fifth position) before returning the build plate to the first position. Advantageously, when the conveyer is in the form of a loop, acceleration and/or deceleration accompanying changing the position or direction of the one or more build plates may be reduced (e.g., relative to an additive manufacturing system with a linear conveyer), which may reduce the time required to fabricate the object (e.g., a device, a component of a device) on the one or more build plates. In some embodiments in which a loop conveyor is used, the loop may include an appropriate inlet and outlet from the conveyor to permit build plates to be selectively input into and removed from the additive manufacturing system. However, the use of a non-continuous conveyor with a separate return mechanism is also envisioned. For example, a return mechanism may be configured so that the one or more build plates can be moved from the second position back to the first position. The return mechanism may be implemented in a variety of ways, including, but not limited to another parallel conveyor running from the second position to the first position, a robotic arm, manual operation, an autonomous ground vehicle, combinations of the foregoing, and/or any other appropriate arrangement as this disclosure is not so limited.

Some embodiments describe a method of making an object (e.g., a device, a component of a device). In some embodiments, a manufacturing method, is described. In some embodiments, the method comprises transporting a build plate from a first location to a second location. In some embodiments, the method comprises selectively activating one or more printheads (e.g., comprising energy sources, comprising lasers of a plurality of laser energy sources and/or one or more binderjets of a plurality of binderjet arrays) disposed between the first location and the second location as the build plate is transported between the first location and the second location to fuse, bind, and/or melt a portion of a layer of material on the build surface.

In some embodiments, the conveyor is configured to guide or direct the motion of one or more the build plates as they move from a first position (e.g., an initial position, an input buffer) to a second position (e.g., a final position, an output buffer). In some embodiments, the conveyer moves one or more build plates with a constant velocity (e.g., an acceleration of zero) as it passes a component of the system, such as printheads (e.g., printheads comprising the laser energy sources and/or the binderjet arrays). During this movement, it may be desirable to provide appropriate structures to reduce vibration, particle generation, and other undesired sources of contamination or disturbance of a powder layer disposed on the build plates. Various suitable techniques can be used to guide the build plates. In some embodiments, the build plates on the conveyer are supported by air bearings, oil hydrostatic bearings, plain bearings, mechanical bearings, magnetic bearings, combinations of the forgoing, or any other appropriate bearing arrangement. Actuation (e.g., movement) of the build plates on the conveyer may be achieved in a variety of ways, including, but not limited to, linear motors, rack-and-pinion drives, and/or belt drives to name a few.

In some embodiments, the conveyer can move at a particular velocity (or move one or more build plates on the conveyer at a particular velocity). In some embodiments, the conveyer moves a build plate at a velocity of greater than or equal to 0.1 m/s, greater than or equal to 0.5 m/s, greater than or equal to 1 m/s, greater than or equal to 2 m/s, greater than or equal to 3 m/s, greater than or equal to 4 m/s, or greater than or equal to 5 m/s. In some embodiments, the conveyer moves a build plate at a velocity of less than or equal to 5 m/s, less than or equal to 4 m/s, less than or equal to 3 m/s, less than or equal to 2 m/s, less than or equal to 1 m/s, less than or equal to 0.5 m/s, or less than or equal to 0.1 m/s. Combinations of the foregoing ranges are possible (e.g., greater than or equal to 0.1 m/s and less than or equal to 5 m/s). Other ranges are possible as this disclosure is not so limited.

In some embodiments, the conveyer comprises one or more sensors (e.g., a camera, an IR sensor, thermal sensors, photodiode sensors). In some such embodiments, the one or more sensors can determine a position or direction of a build plate on the conveyer. In some embodiments, the one or more sensors is associated with a controller of the additive manufacturing system so as to provide synchronization between the conveyer (e.g., a build plate on the conveyer) and another component of the system (e.g., one or more printheads of the system, a plurality of laser energy sources and/or a plurality of binderjet arrays, a recoater). The one or more sensors can be positioned at any point along the conveyer (e.g., proximate to an input buffer, an output buffer, a recoater, etc.).

In some embodiments, one or more build plates on the conveyer may be rotated (e.g., relative to one or more adjacent build plates, relative to printheads of the system). Rotation of the one or more build plates may occur before and/or after a build plate moves between the first position and the second position. In some embodiments, a build plate is rotated after the second position but before returning to the first position. Advantageously, rotation of a build plate prior to returning to the first position may improve the quality of the fabricated component as it is again moved past the printheads (e.g., the plurality of laser energy sources and/or past the plurality of binderjet arrays) by avoiding the formation of multiple layers with the same scan direction which may reduce the resulting stresses formed in the part. Rotation of the one or more build plates may be achieved through using a variety of techniques including, but not limited to, direct drive servo motors, gear driven servo motor, belt driven servo motor, curvic-couplings, face gear couplings, and/or kinematic couplings. Other techniques for rotating the build plates between subsequent layer formation are possible, as this disclosure is not so limited. In some embodiments, the conveyer comprises one or more rotatable stages that may rotate one or more build plates.

In some embodiments, the additive manufacturing system comprises at least one printhead. In some embodiments, the at least one printhead comprises optical assemblies and/or binderjet assemblies (e.g., each may comprise a plurality of optical assemblies and/or binderjet assemblies). In some embodiments, the additive manufacturing system comprises a plurality of optical assemblies where each optical assembly includes a separate plurality of laser energy sources. In some cases, each laser energy source may be configured to selectively actuate each laser to selectively deliver laser energy, in the form of a pixel, to an underlying associated portion of a build surface of a build plate. In some embodiments, each of the plurality of laser energy sources is configured to emit one or more lasers (e.g., laser beams) towards one or more portions of a material layer on the build surface. In some cases, the additive manufacturing system comprises a plurality of binderjet assemblies where each binderjet assembly includes a separate plurality of binderjet arrays. In some embodiments, each binderjet array may be configured to selectively actuate each binderjet to selectively deliver a binder (and/or some other liquid, such as ink), in the form of a pixel, to an underlying associated portion of a build surface of a build plate. In some cases, each of the plurality of binderjet arrays is configured to emit a binder towards one or more portions of a material layer on the build surface. Details regarding suitable binders are described elsewhere herein.

In some embodiments, an optical assembly may comprise additional optical components (e.g., lens, mirrors, beam splitters, etc.) that may further shape and/or direct lasers from the laser energy sources. For the sake of clarity, the various embodiments described herein are primarily directed towards using the laser energy to fuse or melt the powder of a powder layer (e.g., a metallic powder, polymeric powder, or other appropriate meltable powder disposed on the build plates). However, embodiments in which a different material layer and different type of pattern formation technique is used with various embodiments described herein are also envisioned. For example, a curable polymer resin layer may be disposed on the build plate and the laser energy sources may be operated to selectively cure one or more portions of the polymer resin layer, such as by photopolymerization or thermally induced polymerization. In some embodiments, the polymer resin layer may be configured to selectively bind one or more portions of the polymer resin layer, such as a particular functionalization of the polymer resin such that it may bind (e.g., crosslink) at certain portions over others. Accordingly, it should be understood that the various embodiments of a continuous and/or semi-continuous additive manufacturing system including one or more laser energy sources may be used with any appropriate laser-based additive manufacturing process. Additionally, while many of the embodiments described herein a related to the use of laser energy sources, in some embodiments a system may include optics assemblies that include one or more other energy sources which may be combined with any of the embodiments disclosed herein (e.g., embodiments also comprising binderjet assemblies). For example, one or more digital light projectors and/or stereography light sources for use with a photopolymer-based system may be used and/or combined with a binderjet assembly as the disclosure is not so limited. Alternatively, an energy source such as an electron beam source may be used as the energy sources used by the various optics assemblies disclosed herein in place of the described laser beams. Accordingly, the various embodiments disclosed herein may have assemblies including one or more energy sources that are configured to bind, melt, or otherwise fuse, a corresponding material layer disposed on a build plate.

In some embodiments, the plurality of optics assemblies comprises (at least) a first optics assembly and a second optics assembly. The first and second optics assemblies may be adjacent to one another such that the laser energy sources are disposed sequentially along a portion of a length of the conveyor of an additive manufacturing system. In some embodiments, the first optics assembly may be configured to interact with a first portion of a build surface (e.g., cause powder on a particular portion of the build surface to fuse and/or bind when the lasers and/or binderjet arrays are selectively turned on) while the second optics assembly is configured to interact with a second portion of the build surface. In some such embodiments, the first portion and the second portion of the build surface are non-overlapping, such that the lasers of the first and second optics assemblies form fused portions of a material layer disposed on the build plate that do not overlap one another and/or the binderjet array binds portions of a material layer disposed on the build plate that do not overlap one another. In other embodiments, at least a portion of the first portion and the second portion may overlap.

In some embodiments, a binderjet assembly may comprise a binderjets or binderjet systems. In some embodiments, the binderjet assembly may comprise a drop-on-demand binderjet system (e.g., a thermal drop-on-demand system, a piezoelectric drop-on-demand system). In some cases, the binderjet assembly may comprise a continuous binderjet system (e.g., a binderjet system that may continuously provide binder to at least one build plate without interruption of the binderjet array or some other binderjet array within the system). However, in some embodiments, the binderjet assembly may comprise a reservoir of ink, other than a binder, as this disclosure is not so limited.

In some cases, the binder comprises or is a binding agent. Non-limiting examples of binding agents include polymers or metal salts dissolved in aqueous or non-aqueous solution, or photo- or thermally curable compounds comprising one or more monomers and/or oligomers. In some embodiments, the binder comprises a liquid that a component is dissolved or suspended within it (e.g., a liquid resin in which a component is dissolved or suspended), such as particles of a metal or metal alloy or ceramic, without limitation.

The binding agent may be any suitable agent that can be deposited on and/or within powder particles (e.g., powder particles of a material layer) that facilitates binding of the powder particles to one another. Non-limiting examples of binding agents include polyacrylic acids (e.g., having the formula C₃H₄O₂)ₙ or derivatives thereof, where n is a positive integer; acrysols), polyvinyls (e.g., polyvinyl alcohol, polyvinyl acetate), polysiloxanes (e.g., polydimethylsiloxane), styrenes (e.g., acrylonitrile butadiene styrene) and/or butyral resins (e.g., polyvinyl butyral). Additional non-limiting examples of binding agent include, polyvinyl acetate, starch-based adhesives (e.g., carboxymethyl cellulose), acrylates, and/or polyethylene oxide (PEO). Of course, other binding agents are possible and those skilled in the art, in view of this disclosure, will be capable of selecting suitable binding agents. And as was noted above, the binding agent may comprise other components (e.g., metal particles, ceramic particles) that also facilitate binding of the powder particles to one another.

In some embodiments, the binder comprising a component dissolved or suspended within it (e.g., dissolved or suspended in a liquid component of the binder), such as sandstone, silica, stainless steel, particles comprising a metal or metal alloy, and/or tungsten carbide, without limitation.

In some cases, the binderjet assembly may comprise additional components (e.g., pumps, nozzles, one or more reservoirs configured to provide ink or a binder) that may further control dispensing of a binder from the binderjet array. Various embodiments described herein are primarily directed towards using the binder from a binderjet to bind or otherwise fuse the powder of a powder layer (e.g., a metallic powder, polymeric powder, or other appropriate bindable powder) disposed on the build plates. Accordingly, it should be understood that the various embodiments of a continuous and/or semi-continuous additive manufacturing system including one or more binderjet arrays (e.g., a binderjet array) may be used with any appropriate binderjet-based additive manufacturing process.

While various embodiments described herein are related to the use of binderjet arrays, in some embodiments a system may also include binderjet assemblies that include one or more other energy sources which may be combined with any of the embodiments disclosed herein. For example, one or more thermal energy sources (e.g., a laser energy source) used to evaporate a liquid of the ink (e.g., the binder) and/or initiate binding of the binder may be used. In some embodiments, the thermal energy source comprises an infrared lamp (e.g., a heat lamp). In some cases, the thermal energy source evaporates a portion of the binder (e.g., a liquid component of the binder) and/or causes a chemical reaction to occur in the binder and/or between the binder and the powder to set the binder. In some such cases, the binder may set while the build plate is conveying on the conveyor system between cycles of being coated with powder (e.g., when the build plate has been conveyed past the plurality of binderjet arrays but before being recoated by the recoater, as discussed elsewhere herein).

In some embodiments, a light source may be used in combination with the plurality of binderjet assemblies. Non-limiting examples of light sources include lamps, light-emitting diodes, and lasers. Light sources may be used in combination with photo-sensitive binders and/or photo-sensitive powders, wherein illumination of the photo-sensitive binders and/or photo-sensitive powders by the light source initiates a chemical reaction (e.g., crosslinking of a photo-sensitive polymer). In some embodiments, light sources and/or thermal energy sources may be included in a curing head, wherein the binder and the powder and melted and/or fused (e.g., reacted, cured) separately from the binderjet assembly. Accordingly, the various embodiments disclosed herein may have assemblies including one or more energy sources that are configured to melt, or otherwise fuse, a corresponding material layer disposed on a build plate.

In some embodiments, the plurality of binderjet assemblies comprises (at least) a first binderjet assembly and a second binderjet assembly. The first and second binderjet assemblies may be adjacent to one another such that the binderjet arrays are disposed sequentially along a portion of a length of the conveyor of an additive manufacturing system. In some embodiments, the first binderjet assembly may be configured to interact with a first portion of a build surface (e.g., cause powder on a particular portion of the build surface to fuse when the binderjet selectively emits a binder) while the second binderjet assembly is configured to interact with a second portion of the build surface. In some such embodiments, the first portion and the second portion of the build surface are non-overlapping, such that the binderjets of the first and second binderjet assemblies form fused portions of a material layer disposed on the build plate that do not overlap one another. In other embodiments, at least a portion of the first portion and the second portion may overlap. However, it should be understood that any suitable number of binderjet assemblies may be used, and those skilled in the art, in view of the present disclosure, will be capable of selecting an appropriate amount of binderjet assemblies. Accordingly, in some embodiments, additional binderjet assemblies are possible (e.g., a third binderjet assembly, fourth binderjet assembly, fifth binderjet assembly), as this disclosure is not so limited.

As used herein, when an optics assembly and/or a binderjet assembly, laser energy source and/or binderjet array, or a layer is referred to as being “adjacent” to another component, it can be directly adjacent to the other component, or one or more intervening components also may be present. For example, A laser energy source or layer that is “directly adjacent” a component means that no intervening component is present.

The plurality of lasers energy sources within each optics assembly (and/or a corresponding plurality of lasers beams) may be configured to form pixels using laser beams incident on a build surface with a particular spacing. That is to say, each pixel may be spaced apart from adjacent pixels formed by the laser energy sources (e.g., linearly spaced apart, laterally spaced apart, spaced apart in an xy-direction) by a particular distance. In some embodiments, the spacing between adjacent pixels formed on a build surface by an optics assembly may be greater than or equal to 0.5 mm, greater than or equal to 0.6 mm, greater than or equal to 0.7 mm, greater than or equal to 0.8 mm, greater than or equal to 0.9 mm, greater than or equal to 1.0 mm, greater than or equal to 1.2 mm, greater than or equal to 1.5 mm, greater than or equal to 1.7 mm, greater than or equal to 2.0 mm, greater than or equal to 2.5 mm, greater than or equal to 3.0 mm, greater than or equal to 3.5 mm, greater than or equal to 4.0 mm, greater than or equal to 4.5 mm, greater than or equal to 5.0 mm, or greater. In some embodiments, the spacing between the adjacent pixels is less than or equal to 5.0 mm, less than or equal to 4.5 mm, less than or equal to 4.0 mm, less than or equal to 3.5 mm, less than or equal to 3.0 mm, less than or equal to 2.0 mm, less than or equal to 1.7 mm, less than or equal to 1.5 mm, less than or equal to 1.2 mm, less than or equal to 1.0 mm, less than or equal to 0.9 mm, less than or equal to 0.8 mm, less than or equal to 0.7 mm, less than or equal to 0.6 mm, or less than or equal to 0.5 mm, or less. Combinations of the foregoing ranges are also possible (e.g., greater than or equal to 0.5 mm and less than or equal to 5.0 mm). Of course, other ranges are possible as this disclosure is not so limited. Depending on the embodiment, the spacing of adjacent pixels within separate optics assemblies may either be the same or different. For some embodiments, the spacing between adjacent pixels in different optics assemblies is the same. For other embodiments, the spacing between adjacent pixels of at least two optics assemblies is different.

In some embodiments, the plurality of binderjets arranged in an array within each binderjet assembly may be configured to form pixels by emitting a ink (e.g., a binder) incident on a build surface with a particular spacing. That is to say, in some embodiments, each pixel may be spaced apart from adjacent pixels formed by the binderjet arrays (e.g., linearly spaced apart, laterally spaced apart, spaced apart in an xy-direction) by a particular distance. In some embodiments, the spacing between adjacent pixels formed on a build surface by a binderjet assembly may be greater than or equal to 0.5 mm, greater than or equal to 0.6 mm, greater than or equal to 0.7 mm, greater than or equal to 0.8 mm, greater than or equal to 0.9 mm, greater than or equal to 1.0 mm, greater than or equal to 1.2 mm, greater than or equal to 1.5 mm, greater than or equal to 1.7 mm, greater than or equal to 2.0 mm, greater than or equal to 2.5 mm, greater than or equal to 3.0 mm, greater than or equal to 3.5 mm, greater than or equal to 4.0 mm, greater than or equal to 4.5 mm, greater than or equal to 5.0 mm, or greater. In some embodiments, the spacing between the adjacent pixels is less than or equal to 5.0 mm, less than or equal to 4.5 mm, less than or equal to 4.0 mm, less than or equal to 3.5 mm, less than or equal to 3.0 mm, less than or equal to 2.0 mm, less than or equal to 1.7 mm, less than or equal to 1.5 mm, less than or equal to 1.2 mm, less than or equal to 1.0 mm, less than or equal to 0.9 mm, less than or equal to 0.8 mm, less than or equal to 0.7 mm, less than or equal to 0.6 mm, or less than or equal to 0.5 mm, or less. Combinations of the foregoing ranges are also possible (e.g., greater than or equal to 0.5 mm and less than or equal to 5.0 mm). Of course, other ranges are possible as this disclosure is not so limited.

Depending on the embodiment, the spacing of adjacent pixels within separate optics assemblies and/or binderjet assemblies may either be the same or different. For some embodiments, the spacing between adjacent pixels in different optics assemblies and/or binderjet assemblies is the same. For other embodiments, the spacing between adjacent pixels of at least two optics assemblies and/or binderjet assemblies is different.

In some embodiments, each laser of the plurality of lasers energy sources may form objects on the build plate with a particular resolution (e.g., having pixels of a particular size), which may be related to the size (e.g., spot size) of the laser (e.g., laser beam). In some embodiments, an average transverse dimension of a laser beam is greater than or equal to 50 μm, greater than or equal to 75 μm, greater than or equal to 100 μm, greater than or equal to 125 μm, greater than or equal to 150 μm, greater than or equal to 175 μm, or greater than or equal to 200 μm. In some embodiments, an average transverse dimension of a laser beam is less than or equal to 200 μm, less than or equal to 175 μm, less than or equal to 150 μm, less than or equal to 125 μm, less than or equal to 100 μm, less than or equal to 75 μm, or less than or equal to 50 μm. Combinations of the foregoing ranges are also possible (e.g., greater than or equal to 50 μm and less than or equal to 200 μm). Of course, other ranges are possible as this disclosure is not so limited.

In some embodiments, each binderjet in the plurality of binderjet arrays may form objects on the build plate with a particular resolution (e.g., having pixels of a particular size), which may be related to the size (e.g., spot size) of the binderjet nozzle. In some embodiments, an average transverse dimension of a binderjet nozzle is greater than or equal to 50 μm, greater than or equal to 75 μm, greater than or equal to 100 μm, greater than or equal to 125 μm, greater than or equal to 150 μm, greater than or equal to 175 μm, or greater than or equal to 200 μm. In some embodiments, an average transverse dimension of a binderjet is less than or equal to 200 μm, less than or equal to 175 μm, less than or equal to 150 μm, less than or equal to 125 μm, less than or equal to 100 μm, less than or equal to 75 μm, or less than or equal to 50 μm. Combinations of the foregoing ranges are also possible (e.g., greater than or equal to 50 μm and less than or equal to 200 μm). Of course, other ranges are possible as this disclosure is not so limited.

In some embodiments, a printhead (e.g., comprising the lasers of adjacent laser energy sources of optical assemblies and/or the binderjets of adjacent binderjet arrays of binderjet assemblies) of an additive manufacturing system may be offset relative to one another. That is to say, adjacent laser energy sources (e.g., of an optical assembly) and/or binderjet arrays (e.g., or a binderjet assembly) of a conveyer system may be offset from one another in a direction that is transverse to the direction of travel of the conveyer (e.g., a horizontal direction perpendicular to the direction of travel of the conveyer). In some embodiments, the offset distance between lasers in adjacent laser energy and/or binderjets in adjacent binderjet arrays sources is greater than or equal to 0.1 mm, greater than or equal to 0.2 mm, greater than or equal to 0.3 mm, greater than or equal to 0.4 mm, or greater than or equal to 0.5 mm. In some embodiments, the offset distance of two laser energy sources and/or binderjet arrays is less than or equal to 0.5 mm, less than or equal to 0.4 mm, less than or equal to 0.3 mm, less than or equal to 0.2 mm, or less than or equal to 0.1 mm. In some embodiments, two laser energy sources and/or binderjet arrays are not off set (i.e., an offset distance of 0 mm). Combinations of the foregoing range are also possible (e.g., greater than or equal to 0 mm and/or less than or equal to 0.5 mm). Of course, other ranges are possible as this disclosure is not so limited. For embodiments including 3 or more optical assemblies and/or binderjet assemblies, the offset distance in adjacent optical assemblies and/or binderjet assemblies may each independently be the same or different. For some embodiments, the offset distance between lasers of each adjacent laser energy source of the plurality of laser energy sources is the same or different. For other embodiments, the offset distance between lasers of at least two adjacent laser energy sources of the plurality laser energy sources is different than the offset distance of other adjacent laser energy sources of the plurality of laser energy sources. For some embodiments, the offset distance between binderjets of each adjacent binderjet array of the plurality of binderjet arrays is the same or different. For other embodiments, the offset distance between binderjets of at least two adjacent binderjet arrays of the plurality binderjet arrays is different than the offset distance of other adjacent binderjet arrays of the plurality of binderjet arrays.

In some embodiments, at least one of the laser energy sources (and/or optical assemblies) of the plurality of laser energy sources comprises a stationary laser energy source. The stationary laser energy source may stay at a fixed position while other, adjacent laser energy sources of the plurality of laser energy sources may be moved (e.g., in lateral direction, in a z-direction).

In some embodiments, at least one of the binderjet arrays (and/or binderjet assemblies) of the plurality of binderjet arrays comprises a stationary binderjet array. The stationary binderjet array may stay at a fixed position while other, adjacent binderjet arrays of the plurality of binderjet arrays may be moved (e.g., in lateral direction, in a z-direction).

Depending on the particular embodiment, an additive manufacturing system may include any suitable number of printheads (e.g., laser energy sources (and/or corresponding optical fibers providing as number of suitable laser beams) and/or any suitable number of binderjet arrays). For example, in some embodiments, the combined number of lasers in the plurality of energy sources and/or number of binderjets in the plurality of binderjet arrays may each be at least 10, at least 50, at least 100, at least 500, at least 1,000, at least 1,500, at least 2,500, at least 5,000, or more. In some embodiments, the number of lasers in the plurality of laser energy sources and/or the number of binderjets in the plurality of binderjet arrays may each be less than 10,000, 5000, 2,500, 2,000, less than 1,500, less than 1,000, less than 500, less than 100, less than 50, or less than 10. Additionally, combinations of the above-noted ranges may be suitable (e.g., greater than or equal to 10 and less than or equal to 10,000). In an exemplary embodiment, the number of lasers in each of the plurality of laser energy sources is between or equal to 10 and 200. In some embodiment, the number of binderjets in each of the plurality of binderjet arrays is between or equal to 10 and 200. Of course, other ranges are possible as this disclosure is not so limited.

Additionally, in some embodiments, a power output of each laser energy source of a plurality of laser energy sources may each independently be between 50 W and 2,000 W (2 kW). For example, the power output for each laser energy source may be between 100 W and 1.5 kW, and/or between 500 W and 1 kW. Moreover, a total power output of the plurality of laser energy sources may be between 500 W (0.5 kW) and 4,000 kW. For example, the total power output may be between 1 kW and 2,000 kW, and/or between 100 kW and 1,000 kW.

In some embodiments, a size of the binder droplet emitted or deposited from each binderjet of a binderjet array of a plurality of binderjet arrays may have an average diameter of greater than or equal to 50 μm, greater than or equal to 75 μm, greater than or equal to 100 μm, greater than or equal to 125 μm, greater than or equal to 150 μm, greater than or equal to 175 μm, or greater than or equal to 200 μm. In some embodiments, an average diameter of an emitted droplet is less than or equal to 200 μm, less than or equal to 175 μm, less than or equal to 150 μm, less than or equal to 125 μm, less than or equal to 100 μm, less than or equal to 75 μm, or less than or equal to 50 μm. Combinations of the foregoing ranges are also possible (e.g., greater than or equal to 50 μm and less than or equal to 200 μm). Other ranges are also possible.

In some embodiments, the additive manufacturing system further comprises additional laser energy sources and/or additional binderjet arrays. In some such embodiments, the additional laser energy sources and/or additional binderjet arrays may act as redundant laser energy sources and/or additional binderjet arrays in case one or more laser energy sources and/or one or more binderjet arrays enter a failure mode. That is to say, the additional laser energy sources and/or additional binderjet arrays may act as a redundancy in case a laser energy source of the plurality of laser energy sources and/or a binderjet array or the plurality of binderjet arrays has a failure. As will be described in more detail in the context of the figures, when a laser energy source with the plurality of laser energy sources and/or binderjet array in the plurality of binderjet arrays ceases to function, an additional laser energy source and/or binderjet array can be operated to replace one or more of the (failed) lasers energy sources of the plurality of laser energy sources and/or replace the one or more (failed) binderjet arrays in the plurality of binderjet arrays so that additive manufacturing can continue even if one or more of the laser energy sources of the plurality laser energy sources and/or if one or more binderjet arrays in the plurality of binderjet arrays stops working during the manufacturing process.

In some embodiments, an additive manufacturing system includes a recoater. A recoater may either be positioned upstream from an input to the laser energy sources and/or binderjet arrays or downstream from an output from the laser energy sources and/or binderjet arrays such that another material layer, e.g., a powder layer, may be deposited on the one or more build plates of a system prior to recirculating the build plates through the one or more laser energy sources and/or through the one or more binderjet arrays. In some embodiments, a recoater may be positioned in between two lasers energy sources of the plurality of laser energy sources. In some embodiments, a recoater may be positioned in between two binderjet arrays of the plurality of binderjet arrays. In some embodiments, the recoater is a powder recoater that deposits a layer of powder onto the build surfaces of the one or more build plates as the build plates are moved past the recoater.

The material deposited onto a build plate (e.g., a powder, a plurality of particles) may comprise any suitable material desired for forming an object (or a layer of an object). Non-limiting materials may include meltable metal powders, ceramic powders, particles comprising a composite material (e.g., a metal-ceramic composite), and polymer powders in some embodiments. In other embodiments, the material may include a light curable polymer resin. Other appropriate materials capable of being formed using laser energy may also be used as the disclosure is not so limited. In some embodiments, one or more of the plurality of laser energy sources is configured to emit a laser beam to react with a powder. In some embodiments, one or more of the plurality of binderjet arrays is configured to emit a binder to react with, or otherwise fuse, the powder. In some embodiments, the binder chemically reacts with the powder (e.g., crosslinking, displacement reaction, etc). In some cases, after emitting and depositing the binder on the powder, the binder and powder are heated to react (e.g., binding of the binder with one or more powder particles) and/or evaporate a component of the binder. In some such cases, reacting and/or evaporating the component from the binder is the rate-limiting step (e.g., reacting and/or evaporating is slower than the emission of the binder by the binderjet) of the additive manufacturing process (e.g., the reacting and/or evaporating is the slowest step in the additive manufacturing process). However, it should be understood that other techniques may be used to bind, melt, fuse and/or react the powder (e.g., heat, light/electromagnetic radiation, a binder or binding agent, a crosslinking agent) not provided by a laser and/or a binder from a binderjet, as this disclosure is not so limited.

Each layer (e.g., powder layer, a photocurable polymer layer, or other appropriate material layer) deposited on the build plate (or a preceding layer on the build plate) may have a particular thickness. In some embodiments, a thickness of a layer is less than or equal to 500 μm, less than or equal to 250 μm, less than or equal to 100 μm, less than or equal to 50 μm, less than or equal to 25 μm, less than or equal to 10 μm, or less than or equal to 1 μm. In some embodiments, a thickness of a layer is greater than or equal to 1 μm, greater than or equal to 10 μm, greater than or equal to 25 μm, greater than or equal to 50 μm, greater than or equal to 100 μm, greater than or equal to 250 μm, or greater than or equal to 500 μm. Combinations of the foregoing ranges are also possible (e.g., a layer greater than or equal to 1 μm and less than or equal to 500 μm). Other ranges are possible.

As mentioned above, one (or more) objects may be fabricated on a build plate. A build plate provides a surface onto which a material layer (e.g., a build surface) may be deposited, e.g., from a powder for sequentially forming layers of one or more objects on the build surface.

Any suitable material may be used as a build plate. Non-limiting examples of suitable build plate materials include steel, aluminum, titanium, and/or any other appropriate material that in combination with the construction of the build plate may support an object during a build process.

A build plate may have any suitable dimension. In some embodiments, a build plate has at least one transverse dimension that is oriented perpendicular to a direction of the lasers (e.g., a length or depth dimension in a horizontal plane) and at least one transverse dimension that is oriented parallel to a direction of the lasers and/or binderjets (e.g., a length in a vertical plane). In some embodiments, the dimension (e.g., a horizontal dimension and/or a vertical dimension) is greater than or equal to 0.5 mm, greater than or equal to 1 mm, greater than or equal to 5 mm, greater than or equal to 10 mm, greater than or equal to 20 mm, greater than or equal to 25 mm, greater than or equal to 30 mm, greater than or equal to 40 mm, greater than or equal to 50 mm, greater than or equal to 55 mm, greater than or equal to 60 mm, greater than or equal to 70 mm, greater than or equal to 80 mm, greater than or equal to 90 mm, or greater than or equal to 100 mm. In some embodiments, the at least one dimension is less than or equal to 200 mm, less than or equal to 100 mm, less than or equal to 90 mm, less than or equal to 80 mm, less than or equal to 70 mm, less than or equal to 60 mm, less than or equal to 55 mm, less than or equal to 50 mm, less than or equal to 40 mm, less than or equal to 30 mm, less than or equal to 25 mm, less than or equal to 20 mm, less than or equal to 10 mm, less than or equal to 5 mm, less than or equal to 1 mm, or less than or equal to 0.5 mm. Combinations of the foregoing ranges are also possible (e.g., greater than or equal to 0.5 mm and less than or equal to 100 mm). Of course, other ranges are possible as this disclosure is not so limited. When a build plate comprises multiple dimensions, each dimension may independently fall with the above-referenced ranges (e.g., a 3-dimensional build plate having the dimensions of 100 mm×100 mm×0.5 mm). However, embodiments in which one or more of those dimensions is either greater than or less than those noted above are also contemplated.

In some embodiments, a build plate may be disposed on a particular stage (e.g., a height stage, a rotatable stage) to provide support and/or motion to the build plate as the stage and the build plate supported thereon are moved along a conveyor. A height stage which may be configured to change a height of an associated build plate relative to the associated optics assemblies and/or relative to the associated binderjet assemblies may comprise a ball screw drive stage, lead screw drive stage, hydraulic stage, and/or piezoelectric stage, without limitation. Rotation stages which may be configured to change an angular orientation of an associated build plate relative to the associated optics assemblies and/or relative to the associated binderjet assemblies may use direct drive servo motor stages, belt driven servo motor stages, gear driven servo motor stage and/or any other motorized stage to provide support and curvic couplings, face gear couplings, and/or any other kinematic couplings to provide motion and/or rotation to the stage, without limitation. In some embodiments, a stage supporting a build plate thereon may comprise a heater, which may be configured heat the build plate (e.g., a build surface of a build plate).

In some embodiments, an additive manufacturing system comprises a blower. The blower may provide a gas (e.g., air, nitrogen, argon) in order to remove volatile components and/or particulates from the system. In some embodiments, melting or otherwise forming a material (e.g., a powder) using one or more lasers from the plurality of laser energy sources may create byproducts and/or particulates, and a blower may be used to remove these volatile byproducts from the space above the build surfaces as the build plates are moved passed the one or more laser energy sources. In some embodiments, an additive manufacturing system comprises a vacuum that is configured to remove the gas provided by the blower. In some embodiments, a blower is disposed on a first side of the plurality of optics assemblies and/or a vacuum is disposed on a second side of the plurality of optics assemblies opposite from the first side. However, other positions of the blower and/or the vacuum are possible. For example, a separate blower and/or vacuum may be associated with the different optics assemblies and/or may be disposed between the different optics assemblies. Additionally, in some embodiments, one or more blowers, or alternatively, one or more vacuums may be used. In some cases, wherein the additive manufacturing system comprises binderjet assemblies, the blower and/or the vacuum may not be present.

The systems and methods described herein may be suitable for a variety of applications. In some embodiments, the systems and methods may be used to form a device or a component for a device, suitable for device housings for consumer electronics, medical implants, aerospace and defense components, tooling, impellers, automotive components, and/or any other component that may be formed using the additive manufacturing processes described herein. In some embodiments, a digital light processing (DLP, e.g., 3D printing) system may be used in combination with the conveyance systems described herein.

In some embodiments, relative directional terms such as vertical, horizontal, transverse, beneath, above, and other similar terms may be taken relative to a local direction of gravity. For example, a vertical direction may be substantially aligned with a local direction of gravity. In some embodiments, a height or vertical displacement may refer to a distance measured in a direction that is substantially aligned with the local direction of gravity. Similarly, a horizontal direction may be oriented in a direction that is substantially perpendicular to a local direction of gravity. As described herein, dimensions such as a width and/or depth of a component may refer to dimensions that are oriented in a horizontal plane that is substantially perpendicular to a local direction of gravity

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

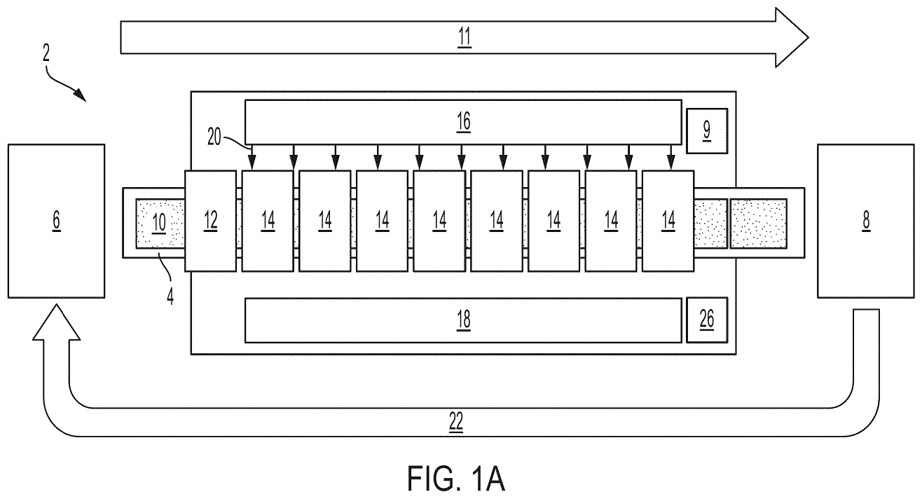

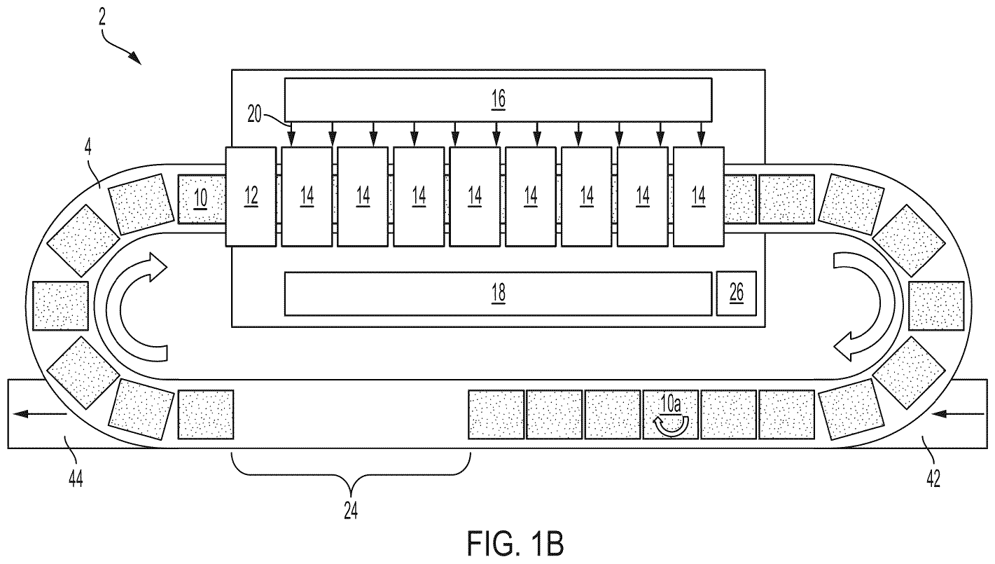

FIG. 1A shows an embodiment of an additive manufacturing system printing objects on build plates. As shown in the figure, the system comprises a conveyor 4, which can carry a plurality of build plates 10 on one or more support stages (not shown) from an input buffer 6 to an output buffer 8. The support stages may be configured to support the one or more build plates while they are transported through the additive manufacturing system. However, embodiments in which the one or more build plates are support directly on a conveyor system without the use of a separate support stage disposed therebetween are also contemplated. The buffers may act as staging locations for multiple build plates that are arranged sequentially both upstream from the input and downstream from the output of the portion of the system including the one or more optics assemblies 14 including separate pluralities of laser energy sources. As the build plates 10 move along the conveyor system 4, the build plates may travel underneath a recoater 12 and the plurality of optics assemblies 14. The recoater may spread a uniform powder layer 32 on the build plates 10. The powder of the powder layer 32 may be configured to transform (e.g., bind, melt, fuse, undergo a polymerization reaction) upon exposure to a source of energy (e.g., light, heat). For example, each optics assemblies may contain a plurality of laser energy sources (not shown). The laser energy sources may be configured to form pixels on a build surface that may be spaced apart from each other, as determined by the focus of the plurality of laser energy sources. A controller 26, which may include a processor and non-transitory memory, may be configured to control the motion of the conveyor 4 and actuation of the laser energy sources of the optics assemblies 14. Specifically, non-transitory memory may include processor executable instructions that when executed by the processor cause the system to perform any of the methods disclosed herein. FIG. 1A also depicts a sensor 9, which can be configured to monitor a position of the one or more build plates 10 as they pass the sensor, and may be coupled to the controller 26, for example, to provide synchronization between the build plates and other portions of the system.

The synchronization of the motion of each build plate with the firing of the lasers may enable melting of the powder of the powder layer such that the object to be formed during sequential layer formation processes has a user-defined shape. As illustrated in FIG. 0.1, the conveyor 4 guides the build plates 10, as well as provides forces to actuate these plates during an acceleration and/or deceleration phase to move the build plates 10 between the input buffer 6 to the output buffer 8 and past the one or more laser energy sources 14. Guidance and actuation of the build plates is described elsewhere herein.

When the laser causes the powder of the powder layer to transform on the build plates, by-products of welding, such as spatter and fumes, are generated. These by-products may be removed, for example, by using a directed gas flow 20, which may be provided a blower 16, as illustrated schematically in FIG. 1A. The directed gas flow and by-products of forming the layer (e.g., via fusion or melting of powder particles of the powder layer) may be removed from the area between the build plates 10 and laser energy sources 14, for example, by using a vacuum 18, as shown in FIG. 1A. Thus, the directed gas flow may flow through a space between the laser energy sources and the one or more build plates passing underneath. It will be understood that while the system can be configured with a single blower 16 and vacuum 18, other configurations are possible. In some embodiments, an individual blower 16 and a vacuum 18 as associated with each laser energy source. In some embodiments, the system includes a single blower with individual vacuum flows associated with (e.g., attached to) each laser energy source. As shown in the figure, the build plates 10 can move in a direction 3, and the blower 16 can provide the directed gas flow 20 in a direction perpendicular to the direction 3.

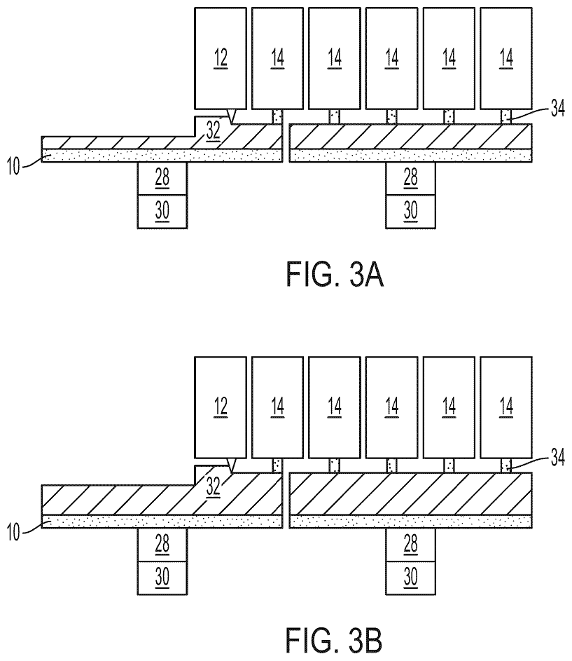

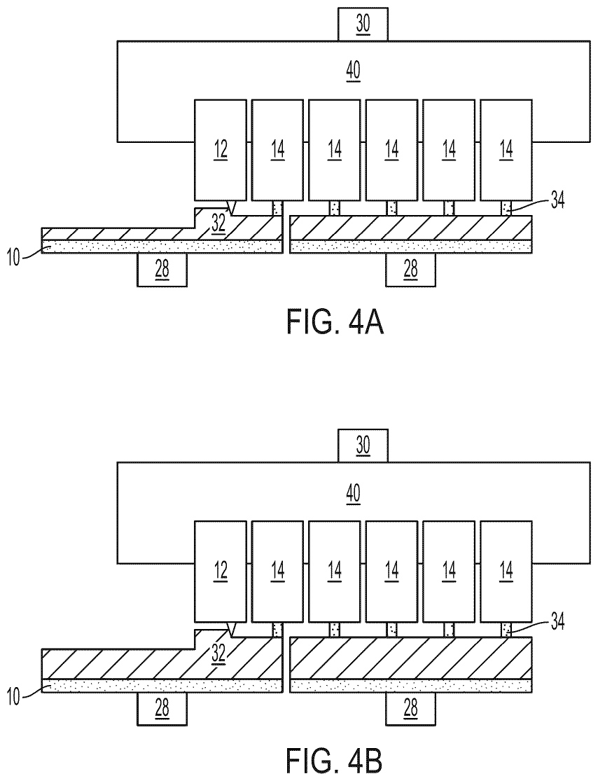

As noted above, each time a build plate moves from its starting position to its ending position and back to its starting position, a new layer may be added to the build plates (e.g., an object forming on the build plate). For example, in FIG. 1A, each pass of the build plates 10 through the optics assemblies 14 may form a desired pattern into one layer of powder or other material. As the build plates reach the output buffer 8, the build plates 10 may move back to the input buffer 6 using the return system 22 within the system for additive manufacturing. This may either be done continuously or using a batch process. Between each pass, the build plates 10 are displaced vertically relative to the recoater 12, optics assemblies 14, blower 16, and/or vacuum 18 using a height stage 30, see FIGS. 3A-4B. This advantageously allows the recoater 12 to spread a new layer of powder without interference from other components of the system. The recoater may either be positioned upstream from a first laser energy source located along a path of the conveyor 4 or downstream from a last laser energy source located along a path of the conveyor depending on what type of return system is used. The vertical motion can be performed by moving each build plate 10 in a direction (e.g., down) away from the recoater 12, and while keeping the recoater 12, optics assemblies 14, blower 16, and/or vacuum 18 stationary, see FIGS. 3A-3B. Alternatively, in another embodiment, the vertical motion can be achieved by keeping the build plates 10 stationary at the same height, and moving the recoater 12, optics assemblies 14, blower 16, and/or vacuum 18 vertically up away from the build plates by a similar or equivalent amount, see FIGS. 4A-4B. Additionally, the build plates can be rotated between layers by a rotation stage (not shown in the figure).

FIG. 1B shows another implementation of an additive manufacturing system. The system includes the conveyor system 4, which forms a closed loop. The conveyor system 4 carries a plurality of build plates 10. As shown in the figure, the conveyer system 4 moves the build plates passed the plurality of optics assemblies 14 and back to the recoater 12. As the build plates 10 move on the conveyor system 4, they may travel underneath a recoater 12 and/or a plurality of optics assemblies 14. The recoater 12 may spread a uniform layer of powder on the build plates 10 as the build plates pass the recoater. Each laser energy source contains a plurality of lasers. The lasers are spaced apart from each other at a particular distance. A controller 26, which may include a processor and non-transitory memory, may be configured to control the motion of the conveyor 4 and actuating the of the laser energy sources of the optics assemblies 14. Specifically, non-transitory memory may include processor executable instructions that when executed by the processor cause the system to perform any of the methods disclosed herein.

The synchronization of the motion of conveyor 4 with the firing of the laser energy sources may enable the fusion or melting of the powder of the powder layer in a user-defined shape. The conveyer 4 can then move the build plate further downstream. When moving the build plates, the conveyor 4 may also include an indexing gap 24 between the first and last build plates 10. This indexing gap 24 may allow the height stage 30 to move the recoater 12, optics assemblies 14, blower 16, and/or vacuum 18 up by the thickness or depth of one layer between the processing of the last build plate and the first build plate of the next layer. This off set distance can be used to index or identify a particular plate among a series of build plates. A build plate may also be rotated by an angle, relative to an adjacent build plate. For example, as shown in the figure, build plate 10a is rotated relative to the adjacent build plate 10. A rotation stage (not shown) may be present on or within the conveyer 4 in order to facilitate rotation of one or more build plates.

In some embodiments, as shown in FIG. 1B, a conveyer 4 may include an inlet 42 and an outlet 44. In such an embodiment, new build plates ready for a new build process may be inserted into the assembly via inlet 42 where the build plates may move from the inlet onto the conveyor. The build plates may then undergo one or more layer formation processes as detailed above to form a desired part. After the formation process is finished, the one or more finished build plates may move from the conveyor into the outlet 44. Thus, it may be possible to both insert and remove build plates from an additive manufacturing system as disclosed herein with minimal down time. Thus, the disclosed systems may operate either continuously or semi-continuously depending on their design and/or operation.

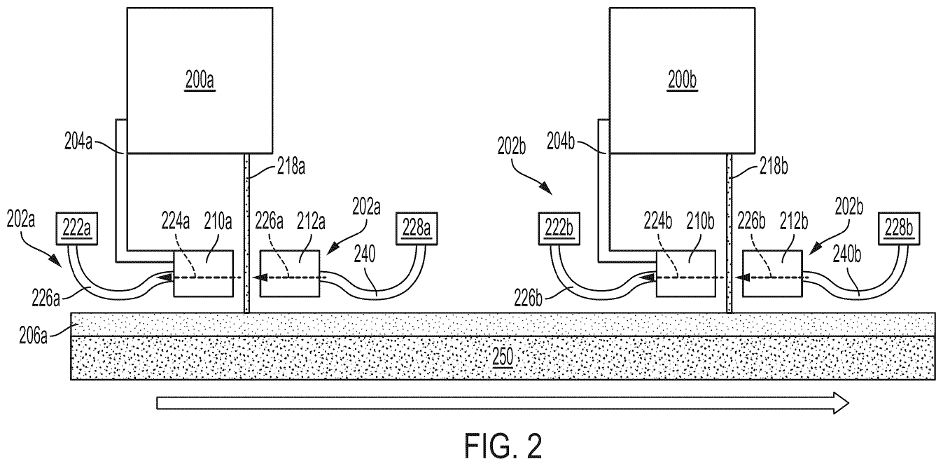

FIG. 2 schematically depicts a cross-sectional side view of a plurality of optics assemblies 200 and blowers 202. The blower 202a may be attached to the optics assembly 200a with a mounting bracket 204a or other appropriate attachment to any appropriate portion of the additive manufacturing system. In this embodiment, a mounting bracket 204a maintains the blower 202a in a fixed position relative to the optics assembly 200a. In this manner, as the one or more build plates 250, with the corresponding material layer 206a disposed thereon, are moved past the optics assembly 200a, the blower may pass a directed gas flow between the optics assembly and a portion of the build plate and material layer exposed to a laser 218a emitted by one or more laser energy sources of the optics assembly. In the depicted embodiment, the blower 202a may include a first portion 210a and a second portion 212a. The first portion 210a disposed upstream from a location where the associated one or more lasers 218a may be directed onto an underlying build plate and material layer the associated optics assembly and the second portion 212a may be disposed downstream from this location. The first and second portions may be at least partially separated by an aperture disposed there between. One or more incident laser beams 218a may pass from the optics assembly 200a, through the aperture and onto the material layer surface 206a. Depending on the embodiment, the aperture may either correspond to an opening or an optically transparent material forming a window that the laser energy may pass through without being substantially absorbed by the window. Energy from the one or more laser beams 218a may create one or more melt pools on the material layer surface and/or may otherwise interact with the material layer to fuse one or more portions of the material layer to form a desired pattern thereon. Any appropriate construction may be used to draw a flow of gas from the volume disposed between the portion of the build plate exposed to the lasers and the corresponding optics assembly. For example, a directed gas flow may be used to evacuate particles, fumes, or gasses ejected from a melt pool. As shown in the figure, a first vacuum supply 222a may draw a flow of gas 224a through the first portion 210a of the blower via a first gas outlet line 226a. A first gas supply 228a may flow a gas 226a through the second portion 212a of the blower via a first gas outlet line 240a. In this manner, gas can be flowed into and removed from both sides of location where the lasers of an associated optics assembly are incident on the material layer 206a and build plate 250.

As shown in the figure, this arrangement of blowers and vacuums disposed at upstream and downstream locations relative to an associated optics assembly may be done for one or more, and in some instances, each of the optics assemblies of a system. For example, as shown in the figure, blower 202b is attached to optics assembly 200b, the latter of which may be another optics assembly of the plurality of optics assemblies. In this manner, the one or more build plates may be translated relative to the optics assembly 200b and associated blower 202b in a manner similar to that described above relative to optics assembly 200a and blower 202a. As with blower 202a, the blower 202b may also include a first and second portions 210b and 212b disposed upstream and downstream from a location of incidence of the one or more lasers 218b on an underlying material layer 206a and build plate 250. Similar to the optics assembly 200a, a second vacuum supply 222b may draw a flow of gas 224b through the first portion 210b of the second blower via a second gas outlet line 226b. A second gas supply 228b may flow a gas through the second portion 212b of the second blower via a second gas inlet line 240b. As with the first laser energy source, gas can be flowed into and removed from both sides of the locations of incidence of the one or more lasers of the associated laser energy source 200b.

While the embodiment depicted in FIG. 2 shows two separate blowers and vacuums for each optics assembly, it should be appreciated that in various embodiments, any appropriate number of vacuum and/or gas supplies may be used with the one or more optics assemblies of a system. Additionally, while the embodiment of FIG. 2 uses corresponding blowers and vacuums to generate the flow of gas, it should be understood that any appropriate method or structure for generating a flow of gas may be used, including, but not limited to, one or more fans, blowers, compressed gas supplies, mechanical compressor systems, vacuum pumps, combinations of the forgoing, and/or any other gas flow generator capable of generating a flow of gas through the blower of any of the embodiments described herein. In embodiments with more than one gas flow generator, also referred to as a blower herein, each gas flow generator may be controlled independently, or they may be cooperatively controlled in order to achieve a desired flow of gas. Additional details regarding blowers and vacuums are described elsewhere herein.

In addition to the above, while the embodiment described in FIG. 2 includes a blower coupled to an optics assembly by a bracket such that the laser energy source and blower can move relative to a material layer with the optical assemblies, embodiments in which the blower and/or vacuum is coupled to a separate frame are also contemplated.

FIGS. 3A-3B schematically depict the vertical movement of the build plates from one layer to the next layer. The height stages 30, which can support the build plates 10, can be used to lower the build plates 10 from one layer to the next. This may increase the relative distance between the recoater 12 and the build plate 10, as shown in the figures. This results in a new powder layer 32 being deposited on top of the previous powder layer. The new powder layer may be smoothed, for example, by a blade or a fin passing over the new powder to a desired and/or pre-determined height (not shown). The lasers 34 may then selectively melt the new powder into a user-desired shape. The recoater and/or the plurality of optic assemblies can be mounted to a stationary frame or some other housing or support (not shown).

FIGS. 4A-4B show the relative motion schematically illustrated in FIGS. 3A-3B between the recoater 12 and build plate 10 being achieved by moving the recoater 12 up instead of moving the build plate 10 down. In some such embodiments, the optic assemblies 14, blower 16, and vacuum 80 and recoater 12 are mounted on a structural frame 40, which is move up with a single height stage 30.

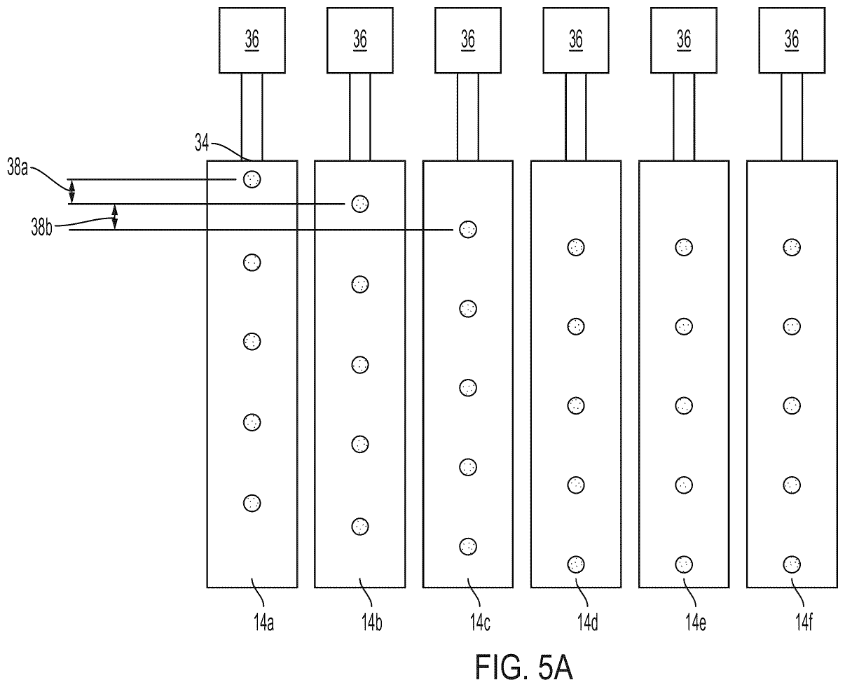

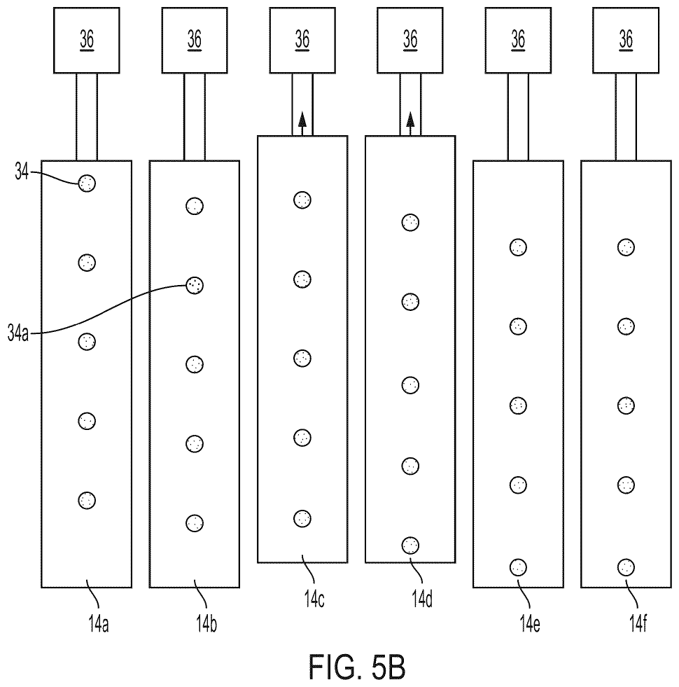

FIGS. 5A and 5B schematically illustrate the mechanism by which optic assemblies may be included in the additive manufacturing system. In some embodiments, the optic assemblies act as redundant optic assemblies and may be used to increase the reliability of the overall system. The system comprises in-use optic assemblies 14a-d, and redundant back-up optic assemblies 14e and 14f. Each optic assemblies contains multiple laser energy sources 34 which are spaced apart linearly with a repeated spacing. The path of the laser beams emitted by the optic assemblies may be perpendicular to the motion of the conveyor 4, or any other non-parallel angle. The arrangement of the optical assemblies are defined such that the one or more laser spots formed on a build surface from a particular optic assembly are laterally disposed within the space between the one or more laser spots formed on the build surface by the one or more other optic assemblies relative to the motion of direction of the conveyor. In this manner, selective exposure of the build plates to laser energy (e.g., laser beams) from the optical assemblies may form a desired pattern on a build surface in a single motion as the build plates pass by the plurality of optical assemblies. Multiple optical assemblies 14 are used to populate the gaps between the laser energy sources 34 in each optical assembly 14. As shown in FIG. 5A, the laser energy sources 34, and/or the corresponding laser spots formed on a build surface, of the optical assembly 14b are offset from the laser energy sources 34, and/or the corresponding laser spots formed on the build surface, in the optical assembly 14a in a direction extending across a width of the laser energy sources and build plates, not depicted, by a laser offset distance 38a. This direction may also be perpendicular to a direction in which the lasers propagate (e.g., in a vertical direction). Similarly, laser energy sources 34 and/or the laser spots formed on the build surface by the optical assembly 14c are offset from the laser energy sources 34 and/or the corresponding laser spots of the optical assembly 14b towards the right by a laser offset distance 38b. Each laser distance may be independently the same or different than other offset distances. Each optical assembly 14 is connected to an optical assembly actuator 36. The optical assembly actuators 36 may be configured to selectively displace the optical assemblies 14 in the offset direction (e.g., a width direction extending perpendicular to a direction of travel of the build surfaces through the system and a vertical direction) by distances at least as large as the largest value of laser offset distance 38 between adjacent optical assemblies 14.

As illustrated in FIG. 5B, redundant optical assemblies 14e and 14f can allow the system to continue to function when a laser in the active optical assemblies 14a-d fail. For example, if a laser energy source 34a on optical assembly 14b is detected to have failed, the system may move the optical assembly 14c using the associated actuator 36 so that the laser energy sources 34 on optical assembly 14c are aligned with the laser energy sources 34 on optical assembly 14b. The controller 26 may modify the laser synchronization commands so that optical assembly 14c executes the commands that optical assembly 14b would have executed. Similarly, optical assembly 14d may be moved by its actuator 36 to its laser energy sources 34 are aligned with the original positions that the laser energy sources 34 of the next upstream optical assembly 14c were located at. The controller 26 may again modify the laser synchronization commands so that moved optical assembly 14d executes the commands the optical assembly 14c that was previously in that transverse position would have executed (had laser 14d not failed). Finally, optical assembly 14e, which is a redundant optical assembly, is moved by its actuator 36 to align with the original position of optical assembly 14d. At the end of this adjustment, optical assembly 14b is disabled, and optical assembly 14e is active. Optical assembly 14f may continue to remain as a redundant optical assembly for any additional potential future optical assembly failures. It should be understood that while a particular number of optical assemblies and redundant optical assemblies are shown in the figures, any number of optical assemblies and redundant optical assemblies may be used as the disclosure is not so limited. Note that while FIGS. 5A and 5B illustrate an exemplary embodiment wherein redundant optical assemblies are used, other embodiments, such as when binderjet assemblies are used in addition to or in place of the optical assemblies, have been contemplated and would be used in a like manner in such additive manufacturing system designs. That is, in some embodiments, redundant binderjet assemblies are used similarly to that shown for optical assemblies in FIGS. 5A and 5B.

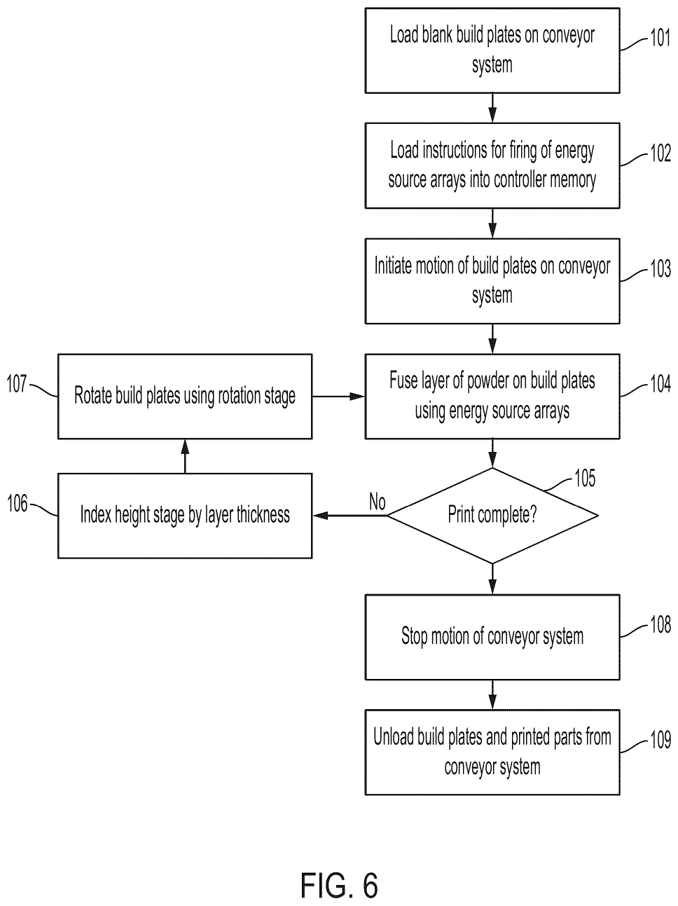

FIG. 6 schematically illustrates a method for operating an additive manufacturing system 2. In the first step 101, blank build plates 10 are loaded onto the conveyor system 4. For example, this may be done by loading the build plates into an inlet of a conveyor system. Alternatively, an automated conveyor inlet may be used to move the one or more build plates into a conveyor system formed as a continuous loop conveyor as previously described above. In the next step 102, the print instructions which include instructions for firing of lasers are loaded into the memory of the controller 26. To start the print, in step 103, the controller 26 instructs the conveyor system 4 to move at a prescribed speed. The speed of motion is part of the print instructions loaded at the beginning of the print. In step 104, one or more portions of a single material layer is fused, or otherwise transformed, on the build plates 10 in one or more locations by the selective operation of the laser energy sources 34, or other light source, of optics of the one or more optical assembly 14. The firing of the lasers may be synchronized with the location of build plates 10 according to the print instructions stored in the controller 26 to provide a desired pattern of fused material on the build surfaces of the build plates. In step 106 a height stage 30 is used to index the build plates 10 down relative to the recoater 12, optical assemblies 14, blower 16, and vacuum 18 by a layer thickness or depth of the layer. This can either be achieved by indexing each build plate 10 down using individual height stages 30, or by indexing the recoater 12, optical assemblies 14, blower 16, and vacuum 18 up using a single or multiple height stages 30 connected to these components as described above. In step 107, the build plates may be rotated by the rotation stage 28 to an appropriate index angle. Steps 104, 106, and 107 are carried out repeatedly until all layers of the print have been fused in the desired locations to provide a desired printed part. At this point, the motion of the conveyor system 4 is stopped, and the printed part and/or the build plates 10 are removed. Alternatively, the one or more build plates that are finished with a formation process may be removed from the conveyor system using a conveyor outlet.

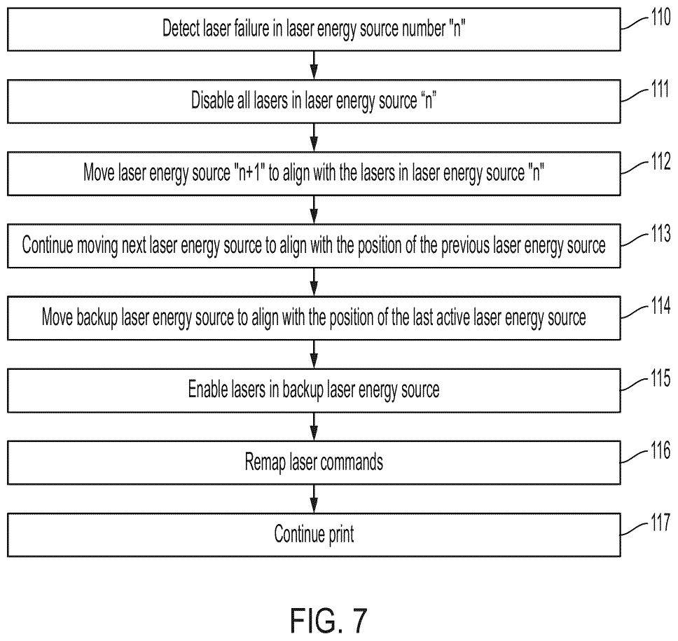

FIG. 7 depicts a sequence of operations to utilize additional optical assemblies, such as the redundant optical assemblies (e.g., 14e, 140 when a failure is detected in one of the active optical assemblies (e.g., 14a-d). Upon the detection of a failure of a laser energy source 34 in an optical assembly (e.g., mechanical, optical, or other type of failure), all laser energy sources 34 in that optical assembly 14 may be disabled (111). In steps 112, 113, and 114, optical assemblies downstream of the failed optical assembly are moved by their respective optical assembly actuators 34 to align with the position of the optical assembly immediately upstream of them, if “n” is the number of the failed optical assembly, optical assembly “n+1” is moved to line up with the position of the failed optical assembly “n” (112), optical assembly “n+2” is moved to line up with the previous position of the next upstream optical assembly “n+1” (113), and so forth. This sequence may be continued or repeated until one optical assembly from the one or more redundant optical assemblies is moved to line up with the initial position of the last active optical assembly 114. Once optical assemblies are physically moved, the laser firing commands are remapped onto different optical assemblies (e.g., by the controller). The laser firing commands executed by optical assembly “n” are executed by optical assembly “n+1,” the commands executed by optical assembly “n+1” are executed by “n+2,” and so forth, until an optical assembly from the plurality of optical assemblies (e.g., the ones that have not failed) and/or the additional optical assemblies may be mapped to execute the commands executed by the last active optical assembly. Once the physical and command remapping is completed, the print (i.e., manufacture of the object) can resume.

The above method may be implemented by one or more controllers including at least one processor operatively coupled to the various controllable portions of an additive manufacturing system as disclosed herein. The method may be embodied as computer readable instructions stored on non-transitory computer readable memory associated with the at least one processor such that when executed by the at least one processor the additive manufacturing system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

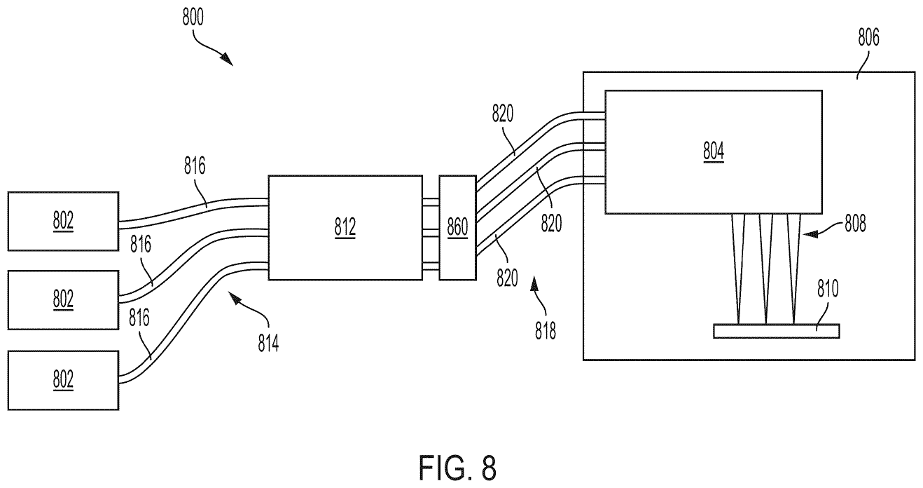

FIG. 8 is a schematic representation of another embodiment of an additive manufacturing system with a more detailed view of the laser energy sources in relation to optical components that provide the lasers (e.g., laser beams). The additive manufacturing system 800 includes a plurality of laser energy sources 802 that deliver laser energy to an optical assembly 804 positioned within a machine enclosure 806. The machine enclosure may define a build volume in which an additive manufacturing process may be carried out (e.g., on a build plate). In particular, the optical assembly may direct laser energy 808 towards a build plate 810 positioned within the machine enclosure to selectively transform (e.g., melt) powdered material on the build surface of the build plate. As described in more detail below, the optical assembly may include a plurality of optical components defining an optical path within the optical assembly that may transform and/or shape and/or direct laser energy within the optical assembly such that the laser energy is directed onto the build surface of a build plate. The optical assembly may be movable within the machine enclosure 806 to scan the laser energy 108 across the build plate 810 during a manufacturing process.

The system 800 further includes an optical fiber connector positioned between the laser energy sources 802 and the optical assembly 804. As illustrated schematically in the figure, a first plurality of optical fibers 814 extends between the plurality of laser energy sources 802 and the optical fiber connector 812. In particular, each laser energy source 802 is coupled to the optical fiber connector 812 via a respective optical fiber 816 of the first plurality of optical fibers 814. Similarly, a second plurality of optical fibers 818 extends between the optical fiber connector 812 and the optical assembly 804. Each optical fiber 816 of the first plurality of optical fibers 814 is coupled to a corresponding optical fiber 820 of the second plurality of optical fibers 818 within the optical fiber connector. In this manner, laser energy from each of the laser energy sources 802 is delivered to the optical assembly 804 such that the laser energy 108 can be directed onto the build surface 810 during an additive manufacturing process (i.e., a build process). Additionally, while the figure depicts parity between the first plurality of optical fibers and the second plurality of optical fibers, other configurations are possible including embodiments in which each laser energy source and associated optical components are configured to form multiple laser beams.

In some instances, the laser energy sources 802 and the optical fiber connector 812 may be stationary relative to the machine enclosure 806. In this manner, the optical fibers 816 of the first plurality of optical fibers 814 may remain substantially stationary throughout a build process, which may aid in avoiding stresses on the optical fibers and/or connections or couplings of the optical fibers, which can lead to failure of the optical fibers. The optical fibers 820 of the second plurality of optical fibers 818 may be movable relative to the stationary optical fiber connector 812 by virtue of their coupling to the movable optical assembly 804. While such movement may impart stresses onto the optical fibers and/or connections or couplings of the optical fibers, aspects described herein may facilitate rapid and simple replacement of the optical fibers 820, as discussed above and in more detail below.

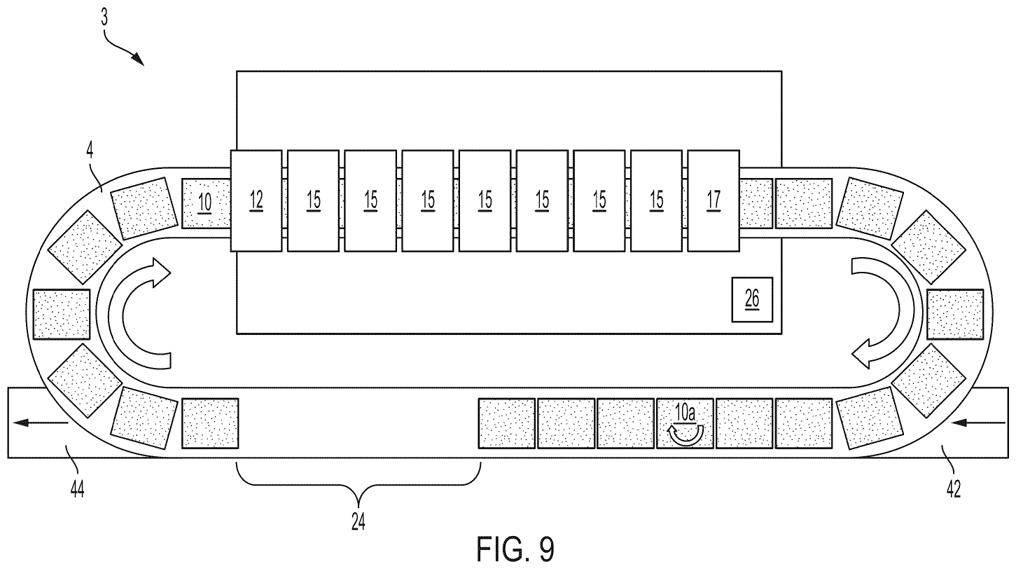

FIG. 9 shows another exemplary embodiment of an additive manufacturing system 3. The system includes the conveyor system 4, which forms a closed loop. The conveyor system 4 carries a plurality of build plates 10. As shown in the figure, the conveyer system 4 moves the build plates 10 passed the plurality of binderjet arrays 15 and back to the recoater 12. As the build plates 10 move on the conveyor system 4, they may travel underneath a recoater 12 and/or a plurality of binderjet arrays 15 and/or a curing head 17. The recoater 12 may spread a uniform layer of powder on the build plates 10 as the build plates pass the recoater. Each binderjet array contains a plurality of binderjets. The binderjets are spaced apart from each other at a particular distance. A controller 26, which may include a processor and non-transitory memory, may be configured to control the motion of the conveyor 4 and actuating of the binderjets of the binderjet arrays 15. Specifically, non-transitory memory may include processor executable instructions that when executed by the processor cause the system to perform any of the methods disclosed herein. As described above in other exemplary embodiments, build plate 10a may be rotated, an indexing gap 24, an inlet 42, and/or an outlet 44 may be used in the additive manufacturing system.

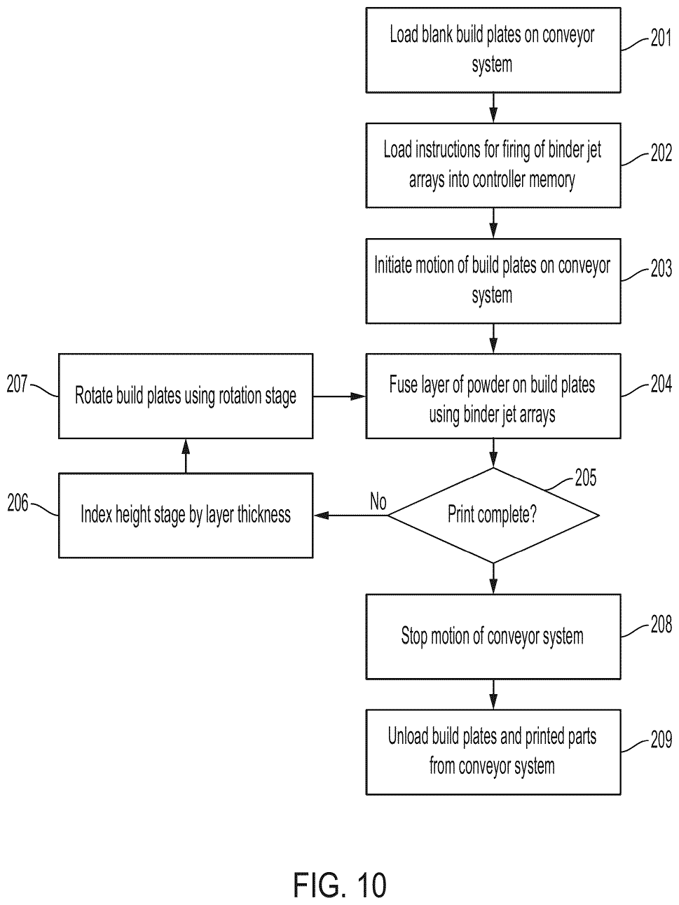

FIG. 10 schematically illustrates a method for operating an additive manufacturing system 2. In the first step 201, blank build plates 10 are loaded onto the conveyor system 4. For example, this may be done by loading the build plates into an inlet of a conveyor system. Alternatively, an automated conveyor inlet may be used to move the one or more build plates into a conveyor system formed as a continuous loop conveyor as previously described above. In the next step 202, the print instructions which include instructions for firing of binderjets are loaded into the memory of the controller 26. To start the print, in step 203, the controller 26 instructs the conveyor system 4 to move at a prescribed speed. The speed of motion is part of the print instructions loaded at the beginning of the print. In step 204, one or more portions of a single material layer is fused, or otherwise transformed, on the build plates 10 in one or more locations by the selective operation of the binderjets and/or binderjet arrays of the binderjet assemblies 15. The firing of the binderjets may be synchronized with the location of build plates 10 according to the print instructions stored in the controller 26 to provide a desired pattern of binder sprayed onto the underlying layer of material to fuse at least a portion of the layer of material in a desired pattern on the build surfaces of the build plates. In step 206 a height stage 30 is used to index the build plates 10 down relative to the recoater 12 and binderjet assemblies 15 by a layer thickness or depth of the layer. This can either be achieved by indexing each build plate 10 down using individual height stages 30, or by indexing the recoater 12 and binderjet assemblies 15 up using a single or multiple height stages 30 connected to these components as described above. In step 207, the build plates may be rotated by the rotation stage 28 to an appropriate index angle. Steps 204, 206, and 207 are carried out repeatedly until all layers of the print have been fused in the desired locations to provide a desired printed part. At this point, the motion of the conveyor system 4 is stopped, and the printed part and/or the build plates 10 are removed. Alternatively, the one or more build plates that are finished with a formation process may be removed from the conveyor system using a conveyor outlet. In some embodiments, the fused portions of the powder layers may be subjected to additional post fusing processes including, but not limited to, sintering. Though embodiments in which sintering is not used are also contemplated.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC or an FPGA, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teaching of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. An additive manufacturing system, comprising:
a conveyer configured to transport a plurality of build plates from a first location to a second location; and
a plurality of printheads disposed between the first location and the second location, wherein each printhead of the plurality of printheads is configured to selectively activate to selectively fuse one or more portions of a material layer disposed on the plurality of build plates as each build plate of the plurality of build plates is transported by the conveyer from the first location to the second location.

2. The additive manufacturing system of claim 1, wherein the plurality of printheads includes a plurality of energy source arrays, and wherein each energy source array of the plurality of energy source arrays is configured to selectively activate and direct energy towards the plurality of build plates as each build plate is transported by the conveyer from the first location to the second location.

3. The additive manufacturing system of claim 2, further comprising a plurality of optical assemblies disposed between the first location and the second location, and where the plurality of energy source arrays are disposed in the plurality of optical assemblies.

4. The additive manufacturing system of claim 2, wherein the plurality of energy source arrays is a plurality of laser energy sources.

5. The additive manufacturing system of claim 2, wherein each energy source array of the plurality of energy source arrays is configured to selectively melt the one or more portions of the material layer.

6. The additive manufacturing system of claim 1, wherein the plurality of printheads is a plurality of binderjet arrays.

7. The additive manufacturing system of claim 6, wherein the plurality of binderjet arrays are configured to selectively spray a binder towards the one or more build plates as each build plate is transported by the conveyer from the first location to the second location.

8. The additive manufacturing system of claim 1, wherein the conveyer is configured to recirculate the build plates from the second location to the first location.

9. The additive manufacturing system of claim 1, further comprising the plurality of build plates.

10. The additive manufacturing system of claim 1, further comprising one or more height stages configured to control a height of the plurality of build plates relative to the plurality of energy source arrays.

11. The additive manufacturing system of claim 1, further comprising one or more rotational stages on the conveyer.

12. The additive manufacturing system of claim 1, wherein the printheads of the plurality of printheads are configured to be stationary during part formation.

13. The additive manufacturing system of claim 1, wherein a spacing between pixels formed by the plurality of printheads is greater than or equal 0.5 mm and/or less than or equal to 5.0 mm.

14. The additive manufacturing system of claim 1, further comprising one or more redundant energy sources.

15. The additive manufacturing system of claim 1, further comprising a recoater configured to apply the material layer to the plurality of build plates.

16. The additive manufacturing system of claim 1, further comprising a blower disposed on a first side of the plurality of laser energy sources and/or a vacuum disposed on a second side of the plurality of laser energy sources opposite from the first side.

17. A manufacturing method, the method comprising:
transporting a build plate from a first location to a second location; and
selectively activating one or more of a plurality of printheads disposed between the first location and the second location as the build plate is transported between the first location and the second location to selectively fuse one or more portions of a material layer on a build surface of the build plate.

18. The method of the claim 17, wherein selectively fusing the one or more portions of the material layer includes directing energy towards the build plate as the build plate is transported from the first location to the second location with a plurality of energy source arrays.

19. The method of claim 18, wherein the plurality of energy source arrays are included in a plurality of optical assemblies disposed between the first location and the second location.

20. The method of claim 17, wherein the plurality of energy source arrays is a plurality of laser energy sources.

21. The method of claim 17, further comprising selectively melting the one or more portions of the material layer with the one or more energy sources.

22. The additive manufacturing system of claim 17, wherein selectively fusing the one or more portions of the material layer includes spraying a binder towards the build plate as the build plate is transported from the first location to the second location with a plurality of binder jet arrays.

23. The method of claim 17, further comprising transporting the build plate from the first location to the second location with a conveyor.

24. The method of claim 17, further comprising transporting the build plate from the second location to the first location.

25. The method of claim 17, further comprising transporting the build plate from the second location to the first location using a closed loop conveyor.

26. The method of claim 17, further comprising transporting a plurality of build plates from the first location to the second location and transporting the plurality of build plates from the second position to the first position.

27. The method of claim 17, further comprising adjusting a height of the build plate relative to the plurality of printheads.

28. The method of claim 17, further comprising rotating the build plate relative to the plurality of energy sources.

29. The method of claim 17, further comprising holding the plurality of printheads stationary during part formation.

30. The method of claim 17, wherein a spacing between pixels formed by the plurality of printheads is greater than or equal 0.5 mm and/or less than or equal to 2.0 mm.

31. The method of claim 17, operating one or more redundant printheads to compensate for a failure of one or more of the plurality of printheads.

32. The method of claim 17, further comprising depositing material onto a surface of the build plate with a recoater to form the material layer.

33. The method of claim 17, further comprising flowing a gas through a space between the plurality of printheads and the build plate.
